(19) United States
(12) Patent Application Publication
(10) Pub. No.: US 2013/0166384 A1
(43) Pub. Date: Jun. 27, 2013

(54) LOCATION-BASED ENCODED DATA FOR FACILITATING TARGETED COMMUNICATIONS

(71) Applicant: Pradeep K. Das, Bethel, CT (US)

(72) Inventor: Pradeep K. Das, Bethel, CT (US)

(73) Assignee: PITNEY BOWES INC., Stamford, CT (US)

(21) Appl. No.: 13/337,486

(22) Filed: Dec. 27, 2011

(51) Int. Cl. G06Q 30/02

(52) U.S. Cl. 705/14.58

(57) ABSTRACT

A system and method to facilitate targeted campaign communications on mobile devices. Rather than rely on the GPS functionality of the mobile device, the method is able to determine the location of the mobile device by determining the location of the campaign media that is being scanned. Location information is embedded in encoded data, such as a 2D barcode or an RFID tag, to be placed the campaign media for this purpose. The campaign entity sends campaign data, including location data, to the campaign preparation servers of the barcode campaign service. The location data can be an address indicating where campaign entity plans to place their campaign media, or a location where campaign entity expects a recipient to receive the campaign media through the mail.

### FIELD OF THE INVENTION

The present invention relates generally to a method for initiating a communication with a mobile communication device through an interaction with a printed media.

### BACKGROUND OF THE INVENTION

Mobile communication devices, like smart phones, with digital camera capabilities are well known. Among other things, a smart phone user may spontaneously take a picture with the camera, and transmit the picture to another phone at a remote location.

Today's phones are recognized as opportunities for greater flexibility and spontaneity in business transactions, and other interactive communications. A smart-phone camera can scan a two dimensional barcode to open an internet browser to access a website address contained in the barcode. Barcodes can be placed on printed media such as posters, magazines, or mail media to allow a mobile device user to access additional information pertinent to the printed media, or to initiate a transaction. Examples of transactions and communications that can be enabled by scanning a barcode with a mobile device are described in U.S. Pat. No. 7,774,283, titled Method and System for Using a Camera Cell Phone in Transactions, which is hereby incorporated by reference in its entirety.

### SUMMARY OF THE INVENTION

The system and method disclosed herein are used to facilitate targeted campaign communications on mobile devices. Rather than rely on a GPS functionality of the mobile device, the method is able to determine the location of the mobile device by determining the location of the campaign media that is being scanned. Location information is embedded in encoded data, such as a 2D barcode or an RFID tag, to be placed on the campaign media for this purpose.

At the beginning of the process, the campaign entity sends data for the intended campaign to the campaign preparation servers of a barcode campaign service. The campaign data includes campaign content information and media placement location data. The campaign content information relates to the information that the campaign entity wishes to communicate to mobile device users, or potential customers. The media placement location data can be an address indicating where campaign entity plans to place their campaign media. In another example, the media placement location data can be a location where campaign entity expects a recipient to receive the campaign media through the mail.

Another feature allows the campaign entity to generate a campaign website based on the campaign content. In an exemplary embodiment, website generation can be done through an interactive website. The campaign entity may be provided with graphical tools and predefined templates to assist in creating the campaign website.

The campaign media created by this system includes a scannable barcode that incorporates data identifying the campaign website and the media placement location. An exemplary format for a scannable barcode is the two dimensional QR Code, known to be easily scannable, and capable of containing sufficient data for the purposes described herein. Alternatively, an encoded RFID tag can be placed on the media in conjunction with the barcode, or instead of the barcode.

The generated campaign media, including the generated encoded data, is provided to the campaign entity. The campaign media document can be transmitted electronically for the campaign entity to print. Alternatively, the campaign media can be printed on a printer associated with the campaign creation computer, and distributed to the campaign entity as part of the service.

After the campaign media has been printed and delivered to its intended location, it is ready to be displayed as part of the interactive campaign. A mobile device user sees the media and decides to scan the barcode, or RFID tag, with his mobile device. The mobile device automatically connects to the campaign website based on the scanning of the barcode or RFID tag. The mobile device also transmits the media placement location data that was in the barcode to the website. Based on the media placement location data received from the mobile device, particular location based communications are selected to be transmitted to the mobile device. In one embodiment, the location-based targeted communications are placed in a banner ad space of the campaign website. In this way, location based targeted messages can be delivered, without relying on the mobile device to provide location information.

Another embodiment of the method addresses the manner in which location based communications from other campaign entities can be selected and incorporated. A second campaign entity may wish to have location based targeted messages sent to mobile device users that are located within a particular area. That second campaign entity can provide their content information and their location criteria to the campaign generation computer. The second campaign entity may, or may not, opt to participate in creating their own campaign website, or their own campaign media.

When determining the location based communication to be sent to the mobile device the second campaign location data is used to find a match to the media placement location data received from the mobile device. In addition to location criteria, other business rules may be applicable to determining which targeted communication to send to the mobile device.

In a preferred embodiment, the media placement location and/or the secondary campaign location information can be input into the system in the form of an address. The addresses can then be geocoded, a process that transforms the address information into a set of geographic coordinates. Those coordinates can be used to more accurately determine matches for location based targeted messages.

### BRIEF DESCRIPTION OF THE DRAWINGS

FIG. 1 depict a system and process flow for creating and receiving campaign media.

FIG. 2 depicts a system and process flow for a mobile device user to receive campaign communications.

FIG. 3 depicts exemplary contents of a 2D barcode.

FIG. 4 depicts exemplary modules in a media campaign server.

FIG. 5 shows steps for creating and distributing campaign media.

FIG. 6 shows steps for providing campaign communications to a mobile device user.

FIG. 7 depicts steps for determining location based messages to be included in the campaign communications.

### DETAILED DESCRIPTION

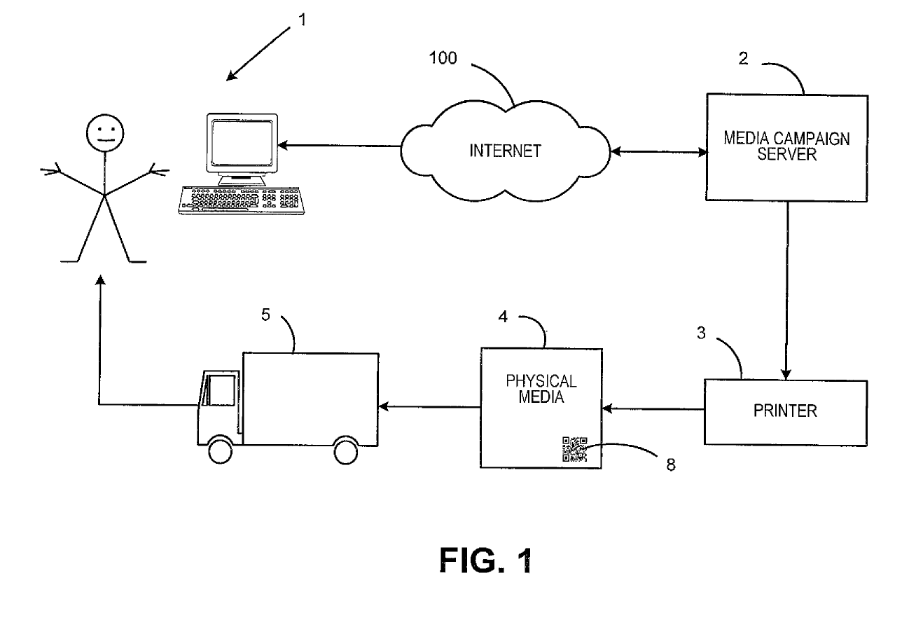

FIG. 1 depicts a system and process flow for a campaign entity 1 to create and receive physical campaign media 4. The campaign entity 1 will typically be a business entity that wishes to create an advertising campaign that includes both physical media 4, such as posters, flyers, or advertisement mailings, and who wishes to have a campaign website linked to that physical media 4. The campaign entity 1 can also be an individual or a government entity wishes to engage in that kind of activity.

In accordance with this process, the campaign entity 1 users a standard personal computer, having internet browsing capability, to access the media campaign server 2 via the internet 100. In a preferred embodiment, the media campaign server 2 maintains a website for purpose of allowing campaign entities 1 access to create campaigns.

Using the media campaign server 2 website, the campaign entity 1 designs the different aspects of the campaign. A first aspect of the campaign is the campaign website. A campaign website will be unique to the campaign entity, and will include details for mobile device users who are interested in obtaining further information with regard to a campaign. Tools are provided on the media campaign server website to assist the campaign entity 1 in uploading information and designing a website for their campaign. Such tools are known in the art, and may include sample formatting, text and graphics to include on a website.

A second aspect of the campaign is the physical media 4. In addition to text and graphics. the physical media includes a 2D barcode 8 that includes data identifying the campaign website address and an intended location for the physical media 4.

In a preferred embodiment, the physical media is printed on a printer 3 that is associated with the media campaign server 2. Then the physical media 4 is delivered to the campaign entity 1 via a delivery service 5. In an alternative embodiment, an electronic version of the document corresponding to the physical media 4 can be transmitted to the campaign entity 1 via the internet 100.

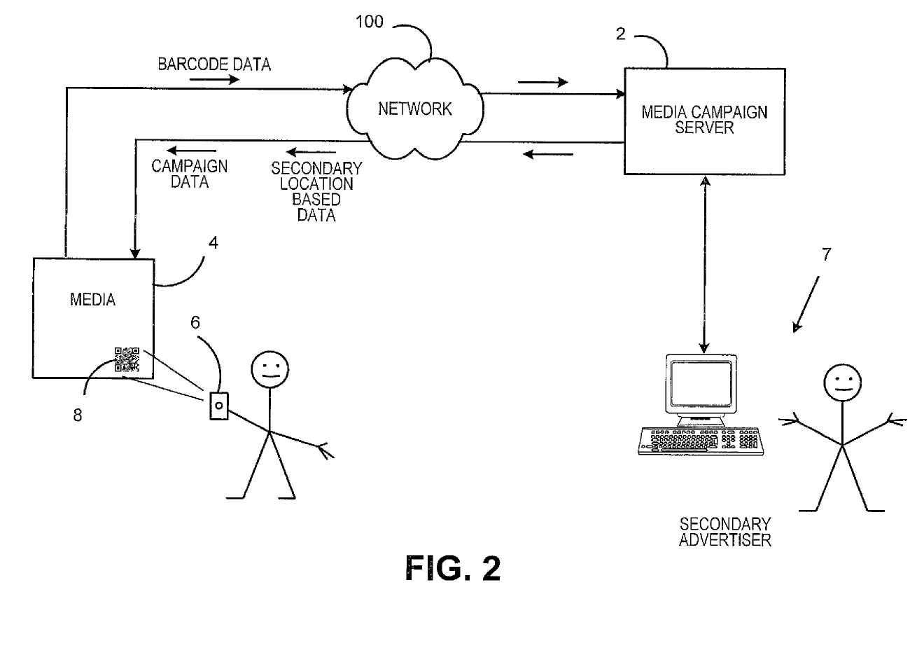

FIG. 2 depicts the interaction of the user of a mobile device 6 with the system and method. The user scans the 2D barcode 8 with the mobile device 6. The mobile device 6 decodes the barcode 8 to derive the website address for the campaign. In this example, the browser of the mobile device 6 accesses the campaign website that is hosted on the media campaign server 2. Campaign data is provided back to the mobile device, presented as part of the campaign website.

In addition to the website address, the mobile device 6 also extracts media location data from the barcode 8 and transmits that data to the media campaign server. Using known location matching algorithms, the media campaign server selects a secondary location based communication to send back to the mobile device, preferably presented as part of the campaign website.

In a preferred embodiment, the secondary location based communications are gathered from secondary advertisers 7 who wish to send their location based targeted messages to mobile device users. Secondary advertisers 7 can identify a geographic area in which they want their targeted messages to be displayed to mobile device 6 users. Secondary advertisers 7 may also identify business rules for circumstances regarding when they wish their targeted messages to be displayed. For example, a business rule may specify the types of media campaigns that a secondary advertisement might accompany, or a time of day when messages should be sent.

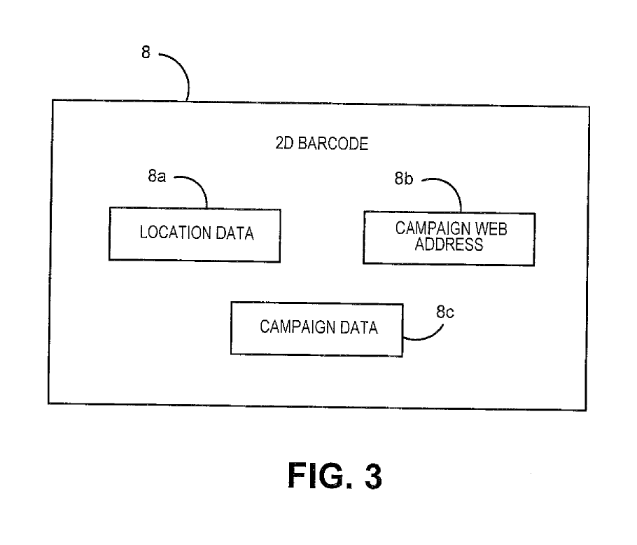

FIG. 3 shows the type of information to be included in the 2D barcode in accordance with the system and method discussed above. In a preferred embodiment. the location data 8a is a set of geographic coordinates (longitude and latitude). These types of coordinates are typically the most useful as input to a system to match geographic proximity for selecting location based messages. Alternatively, the location data 8a can be a street address for the intended location of the physical media 4. The street address can be converted to geographic coordinates through known software for geocoding.

As depicted in FIG. 3, another aspect of the barcode 8 is the data identifying the campaign website. Using known scanning techniques a mobile device 6, such as a smart phone, can use a website address derived from a barcode to automatically cause the internet browser on the smart phone to connect to the website.

The barcode 8 may also include other types of campaign data 8c. For example, if the physical media 4 is offering tickets to a show, or a sale on particular products, the details of those offers may also be included in the barcode to more efficiently bring the most pertinent campaign information to the mobile device 6.

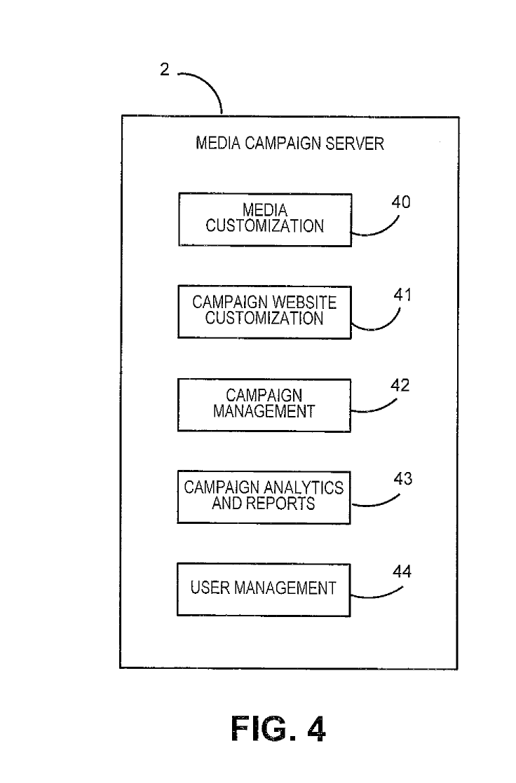

FIG. 4 shows the exemplary components that can comprise the media campaign server 2. As described previously, a media customization module 40 allows a campaign entity 1 to use predefined templates and tools to more easily prepare the text, graphics, and layout of the campaign media 4. Similarly, the campaign website customization tool 41 allows the campaign entity 1 to prepare the website for their campaign. A campaign management tool 42 allows campaign entities 1 to control the real time operation of the campaign and business rules for the campaign website. A campaign analytics and report module 43 provides the ability to gather useful feedback on responses to the media campaign. A user management 41 controls the functions for maintaining the campaign entity's account and subscription for using the services associated with the media campaign server 2.

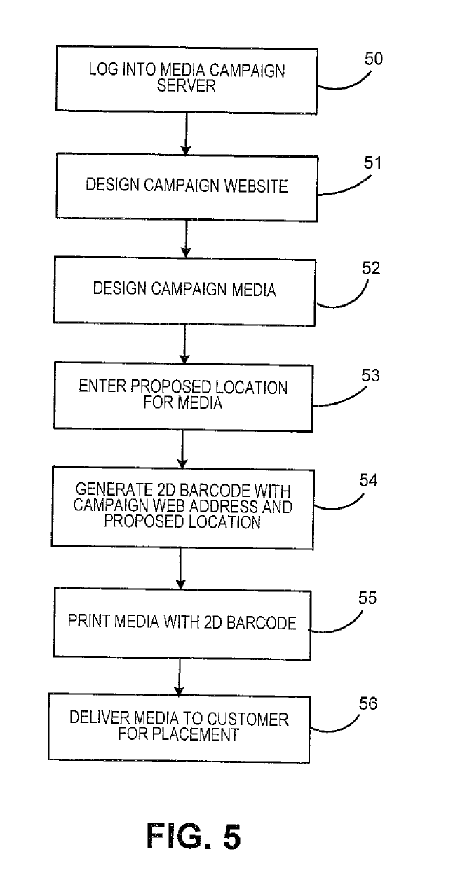

FIG. 5 shows the process steps corresponding to the system depicted in FIG. 1 for generating the physical media 4 and the corresponding campaign website. In step 50 the campaign entity 1 logs into the media campaign server 2, via the Internet 100. When logged into the media campaign server 2, the campaign entity 1 can design the campaign website (step 51), design the campaign media (step 52), and provide the proposed location for the physical media 4 (step 53). At step 54, the media campaign server uses the provided information to generate a 2D barcode with the web address and the location information embedded therein. Next, at step 55, the physical media 4 is printed with the generated barcode. Finally, in the preferred embodiment the printed media is delivered to the campaign entity for placement, or for subsequent mailing, to the intended location.

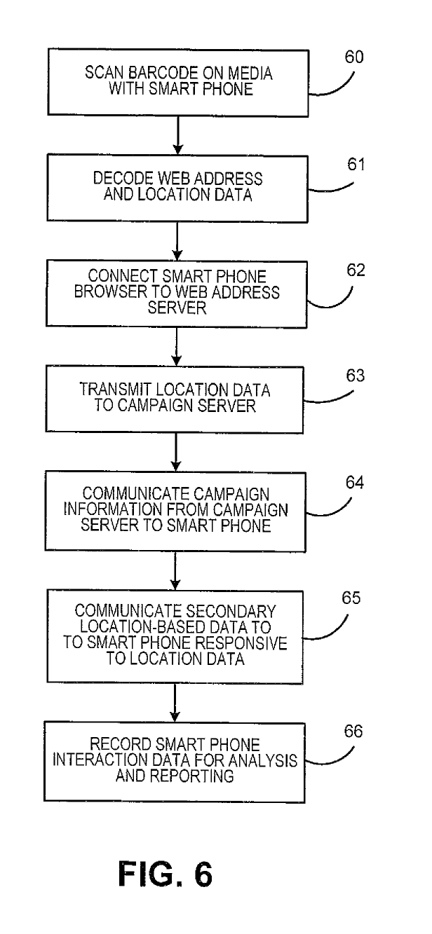

FIG. 6 shows the process steps corresponding to the system depicted in FIG. 2 for an interaction between the mobile device 6 and the media campaign server 2. In step 60, the smart phone scans the barcode on the media. The smart phone decodes the web address and location data from the barcode (step 61). The smart phone connects to the decoded web address (step 62), and transmits the location data to the media campaign server (step 63). The media campaign server communicates website campaign information back to the smart phone (step 64), along with the targeted location based communications selected based on the location data decoded from the barcode (step 65). The media campaign server logs the interactions with the campaign website for purposes of analyzing and reporting on the campaign effectiveness (step 66).

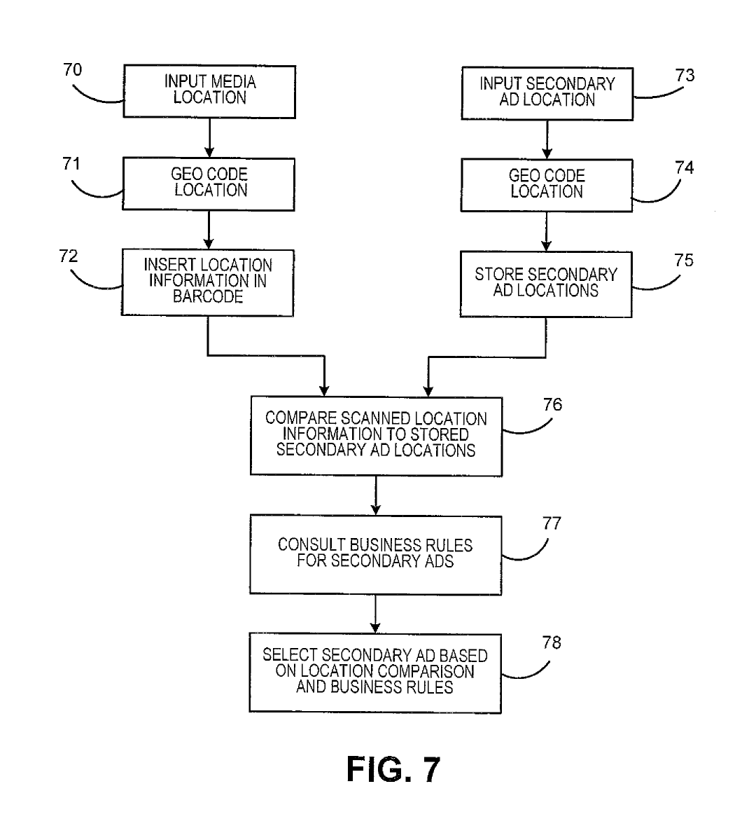

FIG. 7 shows an exemplary process for determining location based targeted messages for transmittal as part of the described system. The campaign entity 1 provides the proposed physical media 4 location to the media campaign server (step 70). In most circumstances, the location will be identified as an address. To better analyze geographic proximities, it is usually preferable for a location to be defined in terms of geographic coordinates. For this reason, an input address will be geocoded to provide a set of coordinates (step 71). The location information is then encoded in the barcode 8 to be placed on the physical media 4 (step 72).

A secondary advertiser 7 also provides location information corresponding to the targeted message that he wants to display (step 73). The secondary advertiser 7 is not necessarily producing a physical campaign media 4, so the geographic preferences are instead based on business rules pertinent to the desired effect. For example, if a store wanted to send targeted messages to potential customer near the store, then the location of the store would be pertinent. Alternatively, secondary advertiser 7 may wish to target people in a particular area because the demographic for that area fits a profile that is compatible with the product or service being advertised.

At step 74, the secondary ad location is geocoded, if it is an address, to get geographic coordinates. The secondary ad geographic coordinates are stored (step 75) in the media campaign server 2 for future comparison for targeted messages at step 76. In addition geographic criteria, other business rules may be applicable for determining the appropriate targeted message (steps 77, 78). There may be time based rules, or rules that certain types of secondary ads are not compatible for placement along with certain types of communication on the primary campaign website. For example, if the campaign website is targeted for children's products, then a secondary ad for nightclubs could be contrary to applicable business rules.

In a further alternative embodiment, the steps of generating and printing the campaign media 4 further includes creating a radio frequency identification (RFID) tag to be placed in conjunction with, or in lieu of, the 2D barcode 8. The same location data 8a, campaign web address data 8b, and campaign data 8c used with the 2D barcode 8 can also be encoded into an RFID tag that is applied to the printed medium 4. The RFID is glued to, or embedded in, the media 4. An exemplary RFID tag suitable for this purpose is a Google NFC tag. Thus, a mobile device 6 can scan the media 4 with either a camera or an RFID scanner, and the same process is followed as described above in connection with FIG. 2.

Although the invention has been described with respect to preferred embodiments thereof, it will be understood by those skilled in the art that the foregoing and various other changes, omissions and deviations in the form and detail thereof may be made without departing from the scope of this invention.

1. A computer method for facilitating targeted campaign communications on mobile devices, the method comprising:
at a campaign creation computer, receiving campaign data from a campaign entity and, as part of the campaign data, receiving:
campaign content information; and
media placement location data;
at the campaign creation computer, generating a campaign website based on the received campaign content information;
at the campaign creation computer, generating campaign media for printing, the step of generating the campaign media including generating encoded data that includes an identification of the campaign website and media placement location data;
providing the generated campaign media, including the generated encoded data, to the campaign entity;
receiving a communication from a mobile device to the campaign website, the communication initiated by the mobile device scanning the encoded data on the campaign media, the received communication including media placement location data; and
transmitting location-based targeted communications to the mobile device based on the media placement location data received from the mobile device.

2. The method of claim 1 wherein the step of providing the generated campaign media includes:
electronically transmitting the generated campaign media to the campaign entity for printing.

3. The method of claim 1 wherein the step of providing the generated campaign media includes:
printing the campaign media on a printer associated with the campaign creation computer; and
distributing the printed campaign media to the campaign entity.

4. The method of claim 1 wherein the step of transmitting location-based targeted communications to the mobile device include placing the location-based targeted communications in a banner ad space of the campaign website.

5. The method of claim 1 further including the step of:
at a campaign creation computer, receiving second campaign data from a second campaign entity and, as part of the second campaign data, receiving:
second campaign content information; and
second campaign location data.

6. The method of claim 5 further including the step of:
matching second campaign location data to the media placement location data received from the mobile device; wherein the step of transmitting location-based targeted communications to the mobile device is further based on the match between the second campaign location data and the media placement location data received from the mobile device.

7. The method of claim 6 wherein the media placement location data and second campaign location data are addresses, and further including a step of geocoding the addresses to determine geographic coordinates of the addresses, and using the geographic coordinates to determine appropriate location-based targeted communications.

8. The method of claim 1 wherein the step of generating the campaign website includes providing an interactive website for the campaign entity to use graphical tools and predefined templates to create the campaign website.

9. The method of claim 1 wherein the media placement location data is a location where the campaign entity plans to display the campaign media.

10. The method of claim 1 wherein the media placement location data is a location where the campaign entity expects a campaign recipient to receive a mailed communication.

11. The method of claim 1 wherein the media placement location data is an address, and further including a step of geocoding the address to determine geographic coordinates of the address, and using the geographic coordinates to determine appropriate location-based targeted communications.

12. The method of claim 1 wherein the step of generating the encoded data generates a barcode to be printed on the campaign media.

13. The method of claim 12 wherein the step of generating the encoded data further generates encoded RFID data to be placed on the campaign media.

14. The method of claim 1 wherein the step of generating the encoded data generates encoded RFID data to be placed on the campaign media.

15. A computer system configured to facilitate targeted campaign communications on mobile devices, the system comprising:
a campaign server computer configured to:
receive campaign data from a campaign entity and, as part of the campaign data, receiving:
campaign content information; and
media placement location data;
generate a campaign website based on the received campaign content information;
generate campaign media for printing, including generating encoded data that includes an identification of the campaign website and media placement location data;
provide the generated campaign media, including the generated encoded data, to the campaign entity;
receive a communication from a mobile device to the campaign website, the communication initiated by the mobile device scanning the barcode on the campaign media, the received communication including media placement location data; and
transmit location-based targeted communications to the mobile device based on the media placement location data received from the mobile device.

16. The computer system of claim 15 wherein the campaign server is further configured to electronically transmit the generated campaign media to the campaign entity for printing.

17. The computer system of claim 15 further including a printer configured to print the campaign media.

18. The computer system of claim 15 wherein the campaign server is further configured to transmit location-based targeted communications to the mobile device include placing the location-based targeted communications in a banner ad space of the campaign website.

19. The computer system of claim 15 wherein the campaign server is further configured to receive second campaign data from a second campaign entity and, as part of the second campaign data, receive second campaign content information, and second campaign location data.

20. The computer system of claim 19 wherein the campaign server is further configured to match second campaign location data to the media placement location data received from the mobile device; wherein the transmitting of location-based targeted communications to the mobile device is further based on the match between the second campaign location data and the media placement location data received from the mobile device.

21. The computer system of claim 20 wherein the media placement location data and second campaign location data are addresses, and the campaign server is further configured to geocode the addresses to determine geographic coordinates of the addresses, and to use the geographic coordinates to determine appropriate location-based targeted communications.

22. The computer system of claim 15 wherein the campaign server is further configured to generate the campaign website by providing an interactive website for the campaign entity to use graphical tools and predefined templates to create the campaign website.

23. The computer system of claim 15 wherein the media placement location data is a location where the campaign entity plans to display the campaign media.

24. The computer system of claim 15 wherein the media placement location data is a location where the campaign entity expects a campaign recipient to receive a mailed communication.

25. The computer system of claim 15 wherein the media placement location data is an address, the campaign server is further configured to geocode the address to determine geographic coordinates of the address, and to use the geographic coordinates to determine appropriate location-based targeted communications.

26. The system of claim 15 wherein the campaign server is further configured to generate the encoded data in the form of a barcode to be printed on the campaign media.

27. The system of claim 26 wherein the campaign server is further configured to generate the encoded data in the form of encoded RFID data to be placed on the campaign media.

28. The system of claim 15 wherein the campaign server is further configured to generate the encoded data in the form of encoded RFID data to be placed on the campaign media.
